(19) United States
(12) Patent Application Publication
(10) Pub. No.: US 2024/0127300 A1
(43) Pub. Date: Apr. 18, 2024

(54) INFERENCE OF RISK DISTRIBUTIONS

(71) Applicant: Dell Products L.P., Round Rock, TX (US)

(72) Inventors: Ofir Ezrielev, Be'er Sheva (IL); Amihai Savir, Newton, MA (US); Noga Gershon, Be'er Sheva (IL)

(21) Appl. No.: 18/047,153

(22) Filed: Oct. 17, 2022

(51) Int. Cl. G06Q 30/02; G06K 9/62; G06N 20/20

(52) U.S. Cl. CPC G06Q 30/0283; G06K 9/6298; G06N 20/20

(57) ABSTRACT

A system can fit an artificial intelligence risk model to data based on labeled training data to produce a fitted model, wherein the labeled training data comprises respective features of users and products, and corresponding labels of respective maintenance costs applicable to the products, and wherein the fitted model comprises a tree model that is configured to differentiate between groups of the data with differing maintenance cost distributions. The system can, in response to applying a first input to the fitted model, produce an output that indicates a predicted maintenance cost distribution, wherein the first input comprises a feature of a user of the users and a product of the products.

### BACKGROUND

Computing resources, such as computing hardware and/or programs, can be made available to a user as a service. This can sometimes be referred to as anything as a service (XaaS).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. A system can fit an artificial intelligence risk model to data based on labeled training data to produce a fitted model, wherein the labeled training data comprises respective features of users and products, and corresponding labels of respective maintenance costs applicable to the products, and wherein the fitted model comprises a tree model that is configured to differentiate between groups of the data with differing maintenance cost distributions. The system can, in response to applying a first input to the fitted model, produce an output that indicates a predicted maintenance cost distribution, wherein the first input comprises a feature of a user of the users and a product of the products.

An example method can comprise fitting, by a system comprising a processor, an artificial intelligence risk model to data based on labeled training data to produce a fitted model, wherein the labeled training data comprises respective features of users and products, and corresponding labels of respective maintenance costs applicable to the products. The method can further comprise, in response to applying a first input to the fitted model, producing, by the system, an output that indicates a predicted maintenance cost distribution, wherein the first input comprises a feature of a user of the users and a product of the products.

An example non-transitory computer-readable medium can comprise instructions that, in response to execution, cause a system comprising a processor to perform operations. These operations can comprise fitting an artificial intelligence risk model to data based on labeled training data to produce a fitted model, wherein the labeled training data comprises respective features of users and products, and corresponding labels of respective maintenance costs applicable to the products. These operations can further comprise, in response to applying a first input to the fitted model, producing an output that indicates a predicted maintenance cost distribution.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate inference of risk distributions, in accordance with an embodiment of this disclosure;

FIG. 2 illustrates another example system architecture that can facilitate inference of risk distributions, in accordance with an embodiment of this disclosure;

FIG. 3 illustrates another example system architecture that can facilitate inference of risk distributions, in accordance with an embodiment of this disclosure;

FIG. 4 illustrates an example process flow that can facilitate inference of risk distributions, in accordance with an embodiment of this disclosure;

FIG. 5 illustrates another example process flow that can facilitate inference of risk distributions, in accordance with an embodiment of this disclosure;

FIG. 6 illustrates another example process flow that can facilitate inference of risk distributions, in accordance with an embodiment of this disclosure;

FIG. 7 illustrates another example process flow that can facilitate inference of risk distributions, in accordance with an embodiment of this disclosure;

FIG. 8 illustrates another example process flow that can facilitate inference of risk distributions, in accordance with an embodiment of this disclosure;

FIG. 9 illustrates another example process flow that can facilitate inference of risk distributions, in accordance with an embodiment of this disclosure;

FIG. 10 illustrates another example system architecture that can facilitate inference of risk distributions, in accordance with an embodiment of this disclosure;

FIG. 11 illustrates an example block diagram of a computer operable to execute an embodiment of this disclosure.

### DETAILED DESCRIPTION

### Overview

Anything as a service can generally comprise a model of providing computing resources as a service. These computing resources can include things such as computing hardware as well as maintenance services for that computing hardware.

In a XaaS model, evaluating a user's predicted support costs (PSC, which can include things such as predicted maintenance costs (PMC)), and adjusting price accordingly, can be valuable. That is, it can be that a user with a higher predicted maintenance cost is to pay more than a user with a lower predicted maintenance cost.

A risk model for evaluating predicted support costs can comprise an explainable artificial intelligence (XAI) model (e.g., a tree gradient boosting model with several trees), which can facilitate later analysis and providing actionable recommendations for users, which can reduce predicted support costs (and pricing), improve a utilization of XaaS products, and increase user satisfaction.

The present techniques can be implemented such that an actionable recommendation engine model works on top of a XAI model, and makes recommendations to users.

Explainable artificial intelligence can generally comprise artificial intelligence (AI) in which results of a solution can be understood by humans. XAI can be contrasted with a concept of a “black box” in machine learning, where even designers of a model cannot explain why AI arrived at a specific decision. XAI can comprise an implementation of a social right to explanation. XAI can be relevant even where there is no legal right or regulatory requirement—for example, XAI can improve user experience of a product or service by helping end users trust that the AI is making good decisions. In this manner, an aim of explainable artificial intelligence can be to explain what has been done, what is being done now, what will be done next, and unveil the information that these actions are based on.

These characteristics of explainable artificial intelligence can make it possible to confirm existing knowledge; to challenge existing knowledge; and to generate new assumptions.

The present techniques can be implemented to provide a way to assess a user's predicted support costs, thus providing a way to more correctly price XaaS products. As different users can require different degrees of maintenance (or other types of support), failure to accurately predict maintenance costs can be a risk. This risk can operate in both directions. That is, users that pose a high risk can be undercharged, and users that pose a low risk can be overcharged.

In addition to accurately predicting maintenance costs, the present techniques can be implemented to help mitigate risky user behavior regarding XaaS offerings. This can be done using interpretable models, which can be “gazed into,” to see what can affect a user's risk, and provide recommendations accordingly.

The present techniques can be implemented to assess a user's predicted support costs, to accurately evaluate costs associated with XaaS products. In addition, where a risk model according to the present techniques is interpretable, this risk model can then be used to provide clear and actionable recommendations to users. Where a user chooses to follow the recommendations, it can be that user costs decrease.

Some prior approaches to XaaS involve flat pricing, with the price being determined solely on the product offering. These approaches can have a problem with disregarding unique characteristics of different users.

The present techniques can be implemented to facilitate an explainable artificial intelligence risk model that can determine a user's predicted support costs given a product offering. The present techniques can also be implemented to facilitate an actionable recommendation engine that utilizes an operating explainable artificial intelligence model.

Data for training an explainable artificial intelligence model can include different kinds of features. These features can include features regarding a user generally, such as the user's industry or the user's size. These features can include features regarding a site, such as the site's geolocation (for temperature, dust amounts, humidity, etc.); an availability, kind, and amount of dust filters at the site; a state of electrical infrastructure at the site; and the site's cooling capabilities. These features can include features regarding a product's usage, such as having user best-practice training (such as for work laptops); laptop battery usage, and electricity using alternating current (AC) or direct current (DC); using up-to-date software and operating systems; and usage patterns, such as a maximal system load encountered, writes per day, past shutdowns, and reported technical incidents (e.g., incidents that did not involve a technician from an entity providing the XaaS offering).

Such an artificial intelligence model's training data can be labeled with maintenance costs incurred for this product offering. It can be that not all relevant information is available at the beginning of implementing the present techniques. There are some models that can freely operate on datasets with missing data. In addition, users can be encouraged to provide more data in exchange for likely reduced pricing.

An explainable artificial intelligence risk model can be used to determine a user's predicted support costs. In some examples, such an explainable artificial intelligence risk model can be implemented with different kinds of machine learning models, such as a decision tree model; a gradient boosting tree model with several trees; a causal tree, such as an uplift tree that differentiates between features that cannot be readily changed (such as a user's industry and size) and features that can be more readily changed (such as a user's site cooling capabilities, electrical infrastructure state, etc.), and can be called treatments; and a graphical causal model.

An explainable artificial intelligence model can generally comprise an artificial intelligence model whose local output (that is, local explainability) or structure (that is, global explainability) can be understood by humans. A causal tree can generally comprise a family of models or processes for causal machine learning, based on trees. An uplift tree can generally comprise a type of causal tree.

A treatment can generally comprise something that is done to an entity, with its information as an immutable input. That is, treatments can comprise things that are essentially mutable (things that are mutable in general, or that are mutable for a given input) in terms of input features. In a recommendation stage according to the present techniques, treatments can be treated as things that can be affected, or changed.

Where an explainable artificial intelligence risk model can quantify risks beyond simply making predictions, the present techniques can be implemented to penalize more on cases where the explainable artificial intelligence risk model determines a lower predicted maintenance cost than has been observed in practice, and penalize less on cases where the explainable artificial intelligence risk model determines a higher predicted maintenance cost than has been observed in practice. This approach can improve a likelihood that an addition of information can reduce a user's predicted support costs where penalty weighting is conditioned on available features. For example, where features A and B are present, a penalization can be 50% weighted for less-than mistakes. Where features A and C are available, the penalization can be 30%.

With a trained explainable artificial intelligence risk model, pricing of a product for subsequent orders can be improved.

With a trained explainable artificial intelligence risk model, actionable recommendations for a user to reduce predicted support costs and improve pricing can be provided according to an actionable recommendation engine.

In an example where decision trees and/or boosting tree models are implemented, an optimization library can be utilized to identify changes that are determined to lead to a lower-model predicted support costs prediction, by creating a wrapper operation around a model's predict operation. The present techniques can also be implemented to control which parameters can be changed, as well as a price of changing them from a user's current values.

In an example where uplift trees are implemented, a counterfactual (e.g., “what would happen if . . . ?”) value estimation technique can be implemented, which can provide in this context similar capabilities as the wrapper operation with decision tree and/or boosting tree model examples.

In another example, techniques can be implemented where, given a model and an observation, a local explanation of the model's prediction can be determined. Based on that local explanation, actionable actions that are customized to a particular user can be provided.

In some examples, the present techniques can be implemented to obtain the following benefits and/or advantages over prior techniques. An advantage can be that, currently, XaaS offerings can have fixed pricing (possibly with discounts), and risk-based offerings are not implemented in an XaaS context. In contrast, the present techniques can be implemented to implement risk-based XaaS offerings.

The present techniques can be implemented to provide an explainable system to drive user change, such as change that can decrease a risk they post to an XaaS offering.

Additionally, the present techniques can be implemented to provide improved pricing based on data; reduced predicting maintenance costs; improved customer satisfaction; and actionable recommendations that can incentivize a user to improve its resource utilization, generally. For example, improving electrical infrastructure and cooling mechanisms can reduce electrical usage, which can mitigate against global warming.

The present techniques can be implemented to facilitate inference of risk distributions. In some examples, it can be that knowing a distribution of risk is preferred to knowing expected values. Furthermore, it can be that a distribution can be a statistical property of many samples, where a machine learning model has problems with learning such a task directly. A solution to this can be to train an uplift or regular decision tree to predict a distribution, with an implementation as follows. A splitting criterion (e.g., entropy or gini impurity) can be a divergence of two resulting distributions of a splits subsets, normalized by their sizes; or by enforcing a minimal size for a leaf node in a tree (where, in some examples, a subset of one sample is not asserted to induce a different probability distribution).

This approach can be distinguished from machine learning techniques where the model is not used for predictions in this approach. Rather, the model can be used to intelligently differentiate between subsets of data.

That is, the present techniques can be implemented to use tree-based models with divergence to differentiate between subsets of data with differing distributions. A benefit of this approach can be to infer risk distributions, which can facilitate users in preparing for multiple possibilities, rather than an average possibility.

The present techniques can be implemented to facilitate differentiated risk costs between risk types. For different users, different types of risk can be more or less costly. For example, it can be that security risks pose a similar risk everywhere. However, it can be that mechanical risks can require sending a representative to a site, so a customer located far away can have a higher cost associated with the same risk.

Implementing differentiated risk costs between risk types can involve identifying different risk types from available data; building a different model for each kind of risk; and fitting risk and recommendation to each user (and/or site) accordingly.

The present techniques can implement multiple models for prediction of different risks, and pricing for each based on user cost-given-risk parameters. This approach can help focus pricing beyond the risk generally, and to different types of risk being priced differently for different users.

The present techniques can be implemented to promote upsales or technology refresh through explainable risk reductions. It can be that older products are more prone to risks than newer ones, even if due to nothing but system wear. As risk rises with time, so can an expected cost, and, consequently, pricing. It can be possible to use a state of a product (in terms of age, wear, etc.) to train a causal model that outputs a risk in a similar manner as an explainable artificial intelligence model as described herein.

Where replacing a product (e.g., a hard drive) is considered as a treatment while training a model—using a counterfactual of a new product can show a user the use of an upgrade or upsale in an explainable way. That is, a user can be shown that, even though there is a cost to an upgrade, a cost pertaining to risk can be reduced. This approach can improve upsales and upgrades.

That is, these techniques can be implemented to determine a risk-decrease due to a user upgrade or upsale. A benefit of these techniques can be to provide transparency with a user regarding a reduction of risk costs due to an upgrade, which can promote the upgrade.

The present techniques can be implemented to provide lead prioritization based on explainable risk reduction. Sales representatives can prioritize possible leads for upsales and tech refreshes, to users with the most to gain from such activities in terms of reduced costs and reduced predicted support costs.

The present techniques can be implemented to provide dynamic pricing based on explainable risk reduction. Pricing teams can have more information to use to create special offers to users, and thus increase a probability that a sale will succeed.

In some examples, historical data of maintenance costs can be used in determining predicted support costs of recurring users. In addition, in some examples, models that are trained for new and recurring users can be inherently different (e.g., in terms of structure, features, risk, loss/penalty modifiers, etc.).

### Example Architectures

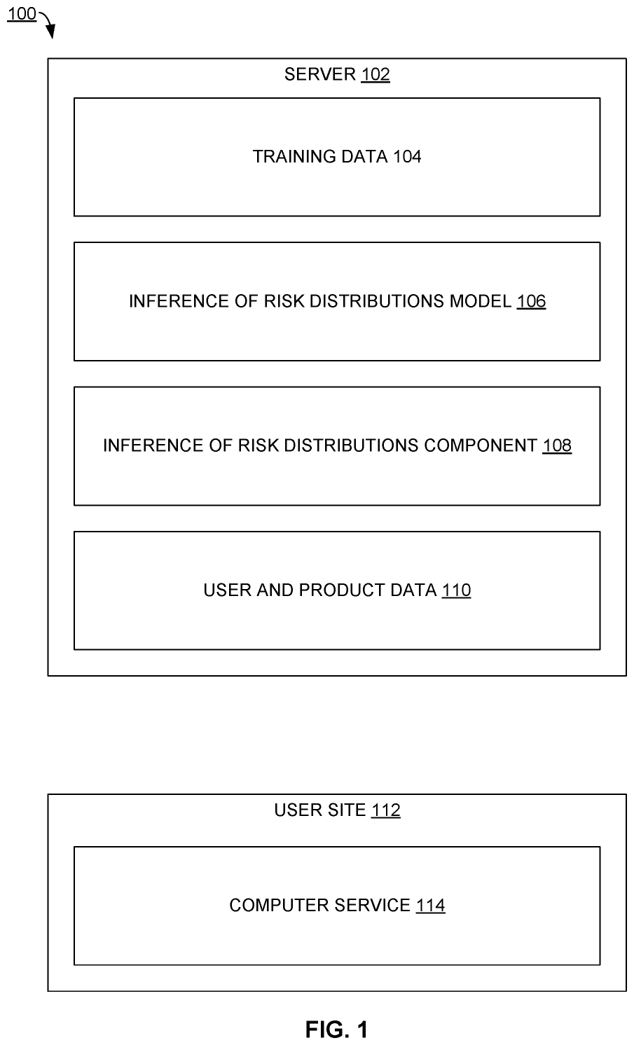

FIG. 1 illustrates an example system architecture 100 that can facilitate inference of risk distributions, in accordance with an embodiment of this disclosure.

System architecture 100 comprises server 102 and user site 112. In turn, server 102 comprises training data 104, inference of risk distributions model 106, inference of risk distributions component 108, and user and product data 110. Likewise, in turn user site 112 comprises computer service 114.

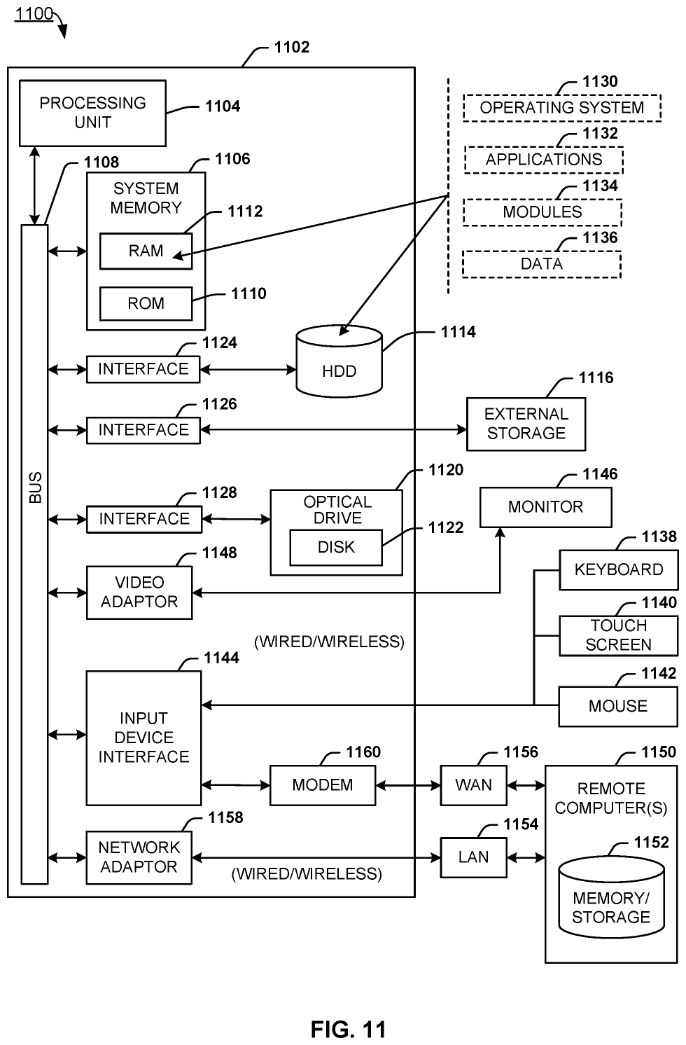

Each of server 102 and/or user site 112 can be implemented with part(s) of computing environment 1100 of FIG. 11.

Training data 104 can comprise labeled training data that is used in supervised training of a machine learning model. Training data 104 can comprise features of users and/or products that are labeled with respective predicted support costs. Inference of risk distributions component 108 can supply training data 104 to inference of risk distributions model 106 to train inference of risk distributions model 106 to produce a predicted maintenance cost for a given input of one or more features about users and corresponding products.

Once trained, inference of risk distributions model 106 can take part(s) of user and product data 110 as input, and produce a corresponding output that identifies a predicted maintenance cost. For example, inference of risk distributions model 106 can take input regarding user site 112 and computer service 114 and produce an output indicating a predicted maintenance cost for operating computer service 114 for a given user at user site 112.

User site 112 can comprise a physical site associated with a particular user account. In addition to having a particular physical location, user site 112 can have other characteristics, such as temperature, humidity, amount of dust in the air, capability to remove dust from the air, capability to cool the site, and state of electrical infrastructure to the site. Computer service 114 can comprise a computer service provided to a user account associated with user site 112. In some examples, computer service 114 can comprise a particular type, amount, and configuration of computer hardware. In some examples, computer service 114 can comprise a computer program or computer capability, such as an ability to access cloud-based computer storage. In some examples, computer service 114 can be referred to as a service where the user account associated with computer service has access to computer service 114 for a set amount of time (which can be recurring, or in some examples, undefined at the outset though it can be ended on short notice) rather than owning computer service 114 outright.

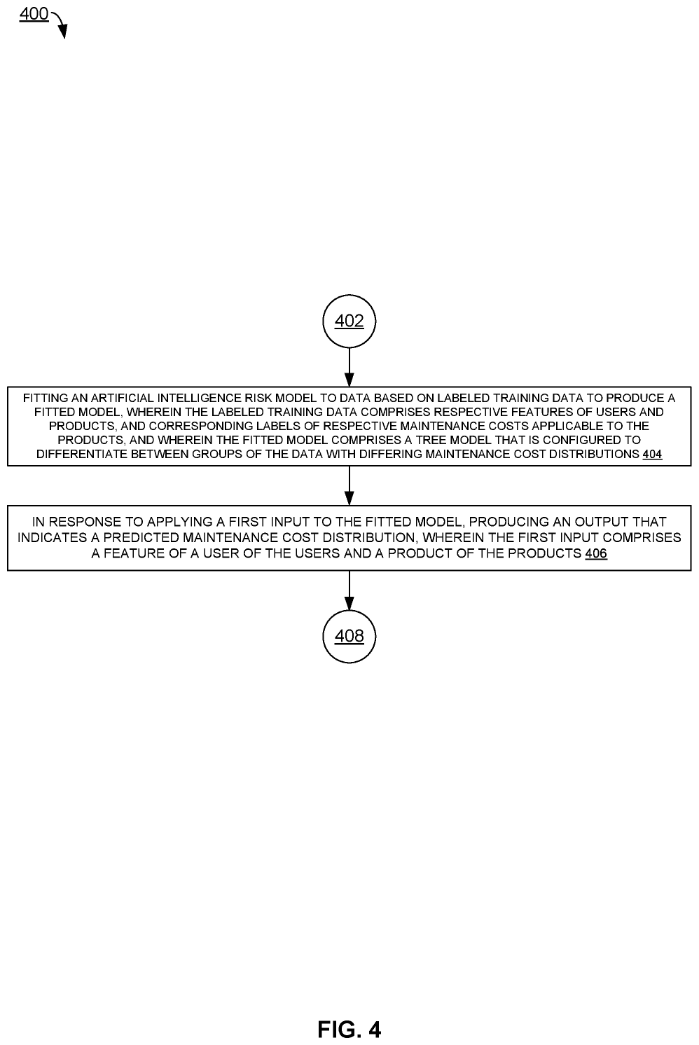

In some examples, inference of risk distributions component 108 can implement part(s) of the process flows of FIGS. 4-9 to facilitate inference of risk distributions.

In some examples, inference of risk distributions component 108 can identify a technology refresh for computer service 114 for a user account associated with user site 112 that will lower a predicted maintenance cost or risk distribution for the computer service. In such examples, inference of risk distributions component 108 can then recommend the technology refresh for computer service 114 to the user account.

It can be appreciated that system architecture 100 is one example system architecture for inference of risk distributions, and that there can be other system architectures that facilitate inference of risk distributions.

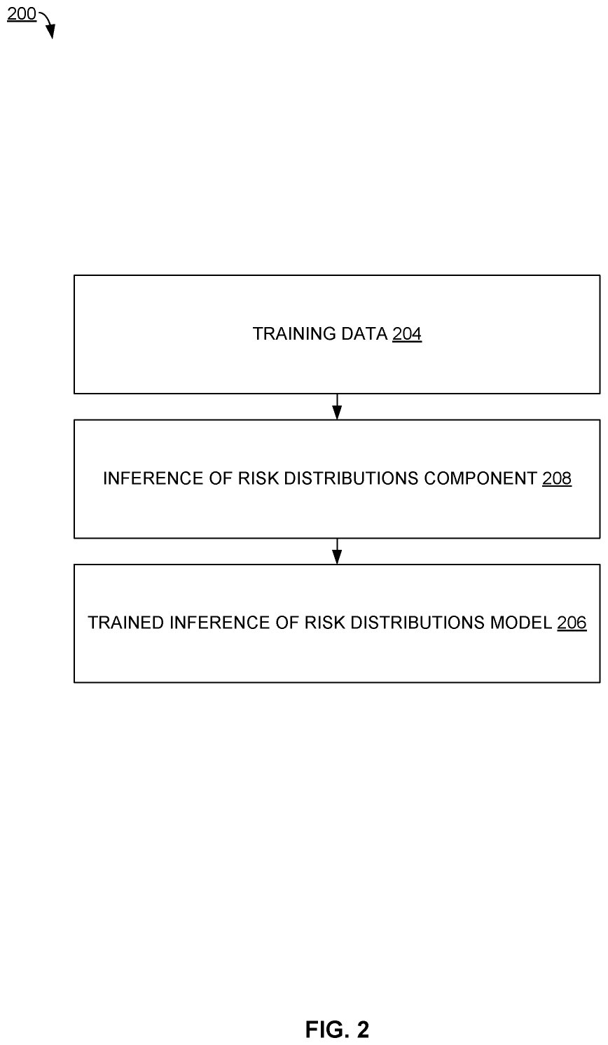

FIG. 2 illustrates another example system architecture 200 that can facilitate inference of risk distributions, in accordance with an embodiment of this disclosure. In some examples, part(s) of system architecture 200 can be used to implement part(s) of system architecture 100 of FIG. 1.

System architecture 200 comprises training data 204, inference of risk distributions component 208, and trained inference of risk distributions model 206. In some examples, training data 204 can be similar to training data 104 of FIG. 1. In some examples, inference of risk distributions component 208 can be similar to inference of risk distributions component 108 of FIG. 1. In some examples, trained inference of risk distributions model 206 can be similar to inference of risk distributions model 106 of FIG. 1, where inference of risk distributions model 106 has been trained.

In system architecture 200, training data 204 can be input to inference of risk distributions component 208. Inference of risk distributions component 208 can process training data 204 and correspondingly output trained inference of risk distributions model 206.

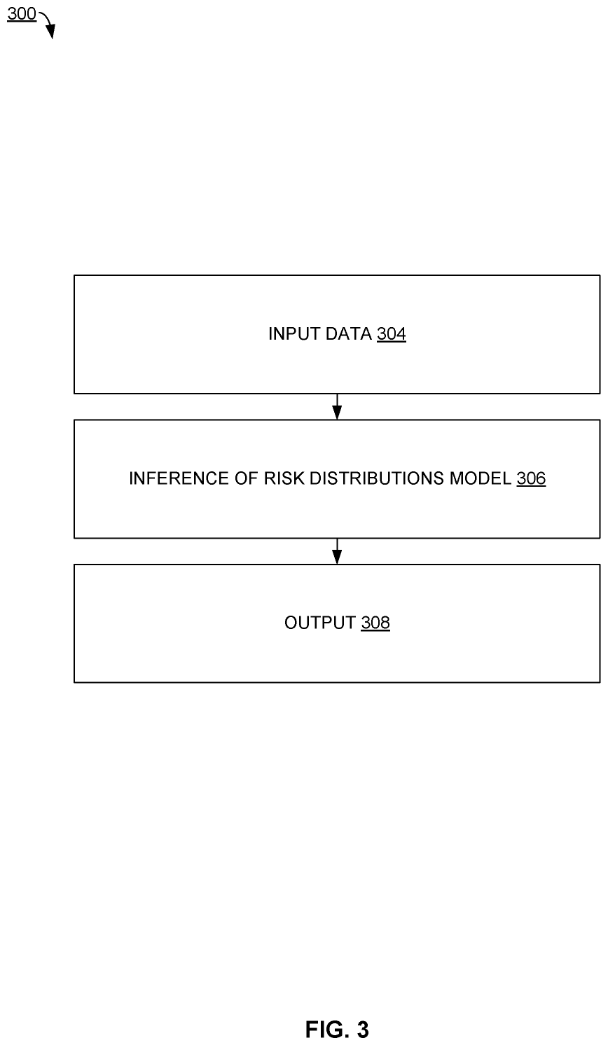

FIG. 3 illustrates another example system architecture 300 that can facilitate inference of risk distributions, in accordance with an embodiment of this disclosure. In some examples, part(s) of system architecture 300 can be used to implement part(s) of system architecture 100 of FIG. 1.

System architecture 300 comprises input data 304, trained inference of risk distributions model 306, and output 308. In some examples, input data 304 can be similar to user and product data 110 of FIG. 1. In some examples, trained inference of risk distributions model 306 can be similar to trained inference of risk distributions model 206 of FIG. 2. In some examples, output 308 can comprise an indication of a predicted maintenance cost for a user account and service indicated by input data 304.

In system architecture 300, training data 204 can be input to trained inference of risk distributions model 306. Trained inference of risk distributions model 306 can process training data 204, and from input data 204, produce corresponding output 308.

### Example Process Flows

FIG. 4 illustrates an example process flow 400 that can facilitate inference of risk distributions, in accordance with an embodiment of this disclosure. In some examples, one or more embodiments of process flow 400 can be implemented by inference of risk distributions component 108 of FIG. 1, or computing environment 1100 of FIG. 11.

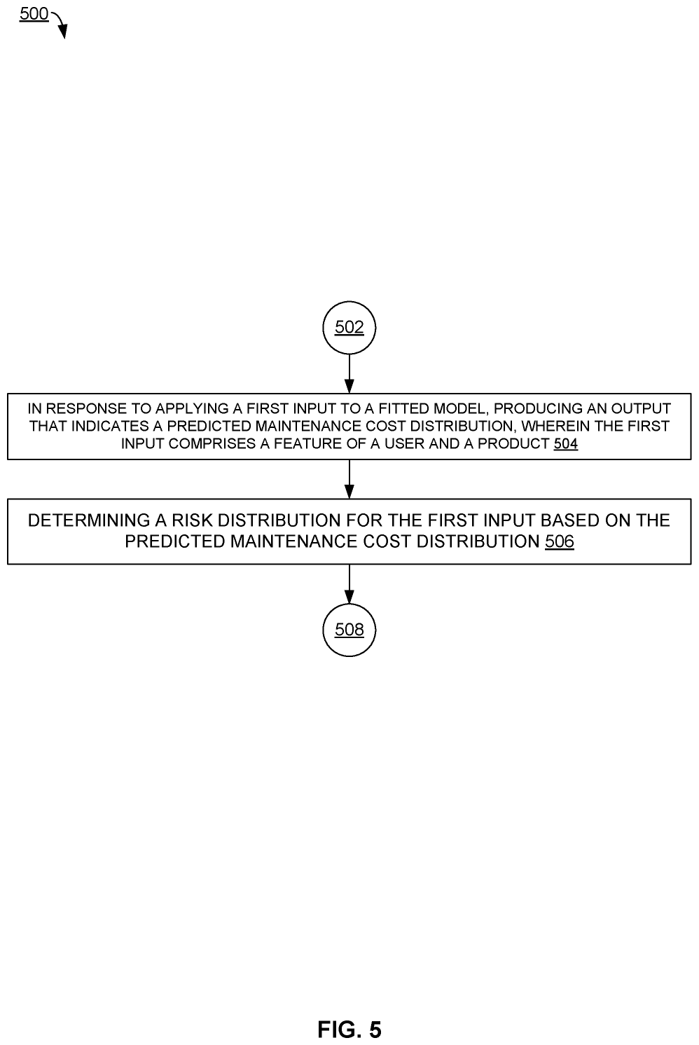

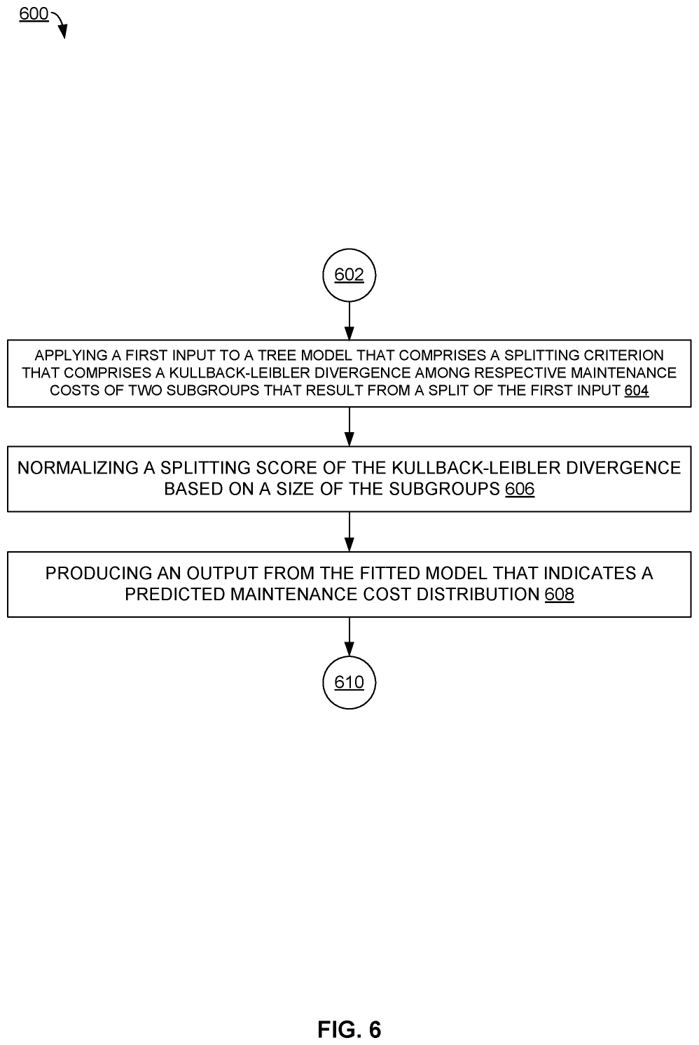

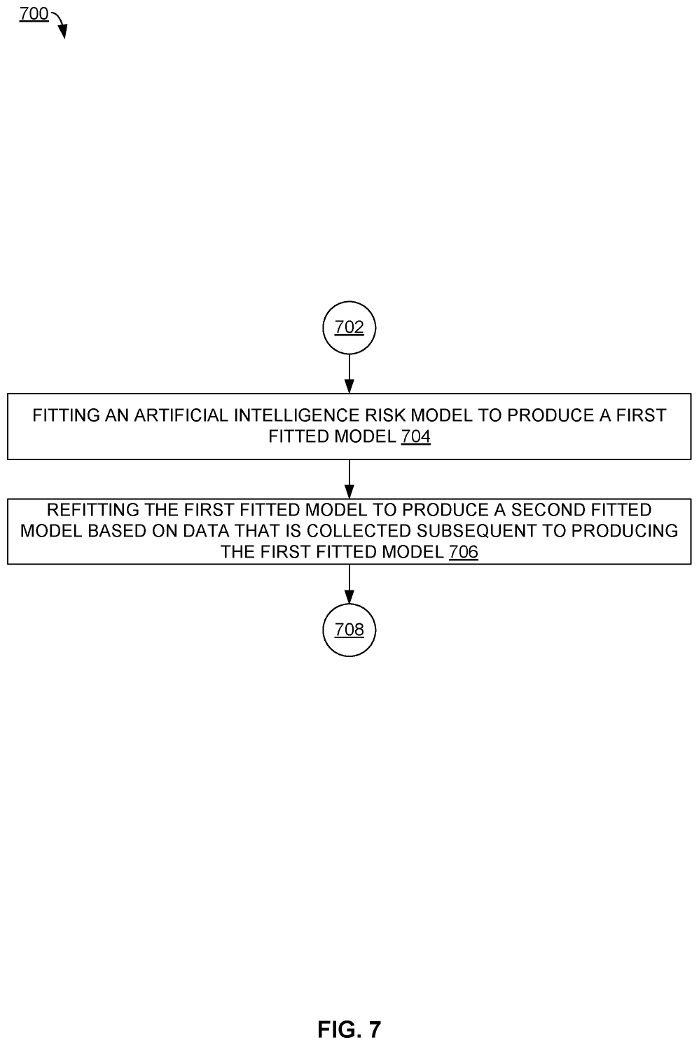

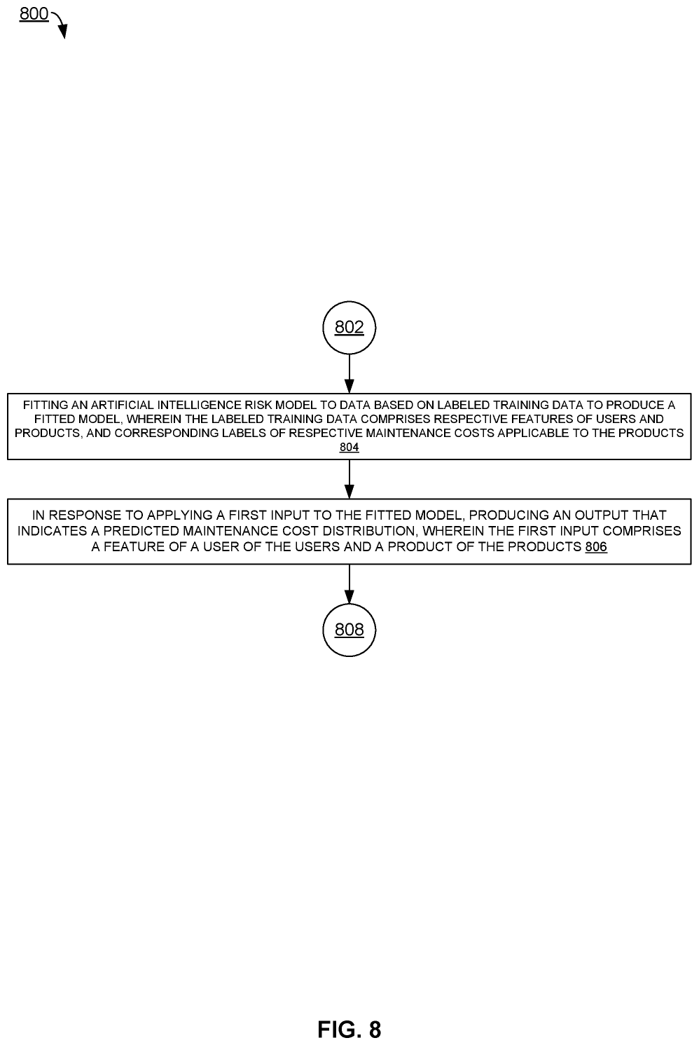

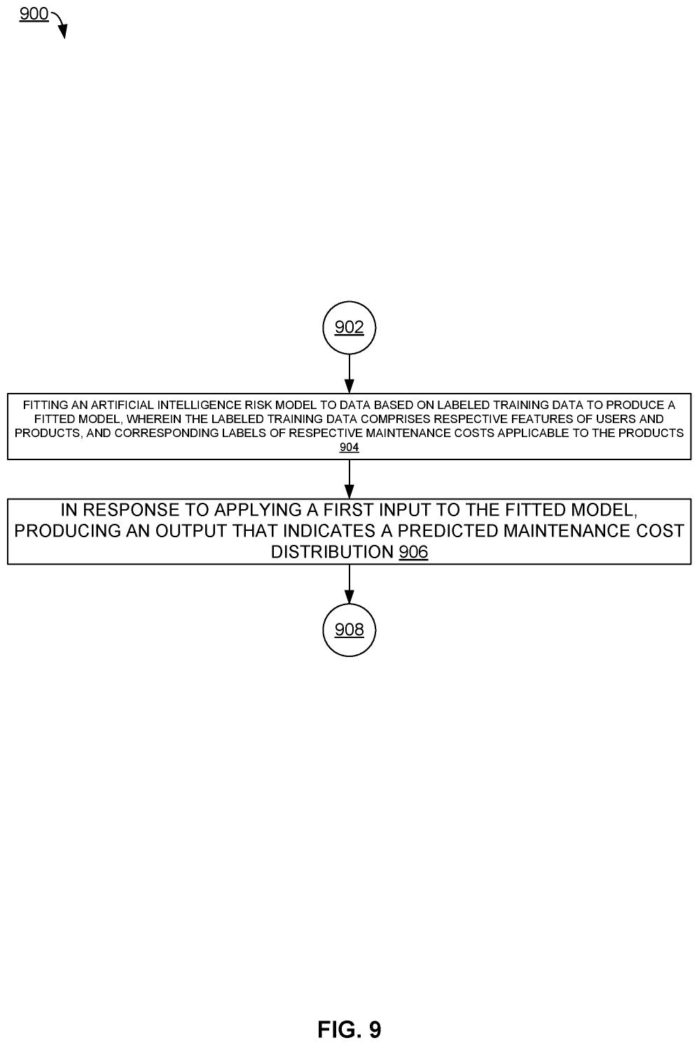

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, and/or process flow 900 of FIG. 9.

Process flow 400 begins with 402, and moves to operation 404. Operation 404 depicts fitting an artificial intelligence risk model to data based on labeled training data to produce a fitted model, wherein the labeled training data comprises respective features of users and products, and corresponding labels of respective maintenance costs applicable to the products, and wherein the fitted model comprises a tree model that is configured to differentiate between groups of the data with differing maintenance cost distributions. That is, a model can be trained using supervised learning so that, for a given use account and computer product used by the user account, the model can predict future maintenance costs for that computer product, such as a distribution of predicted future maintenance costs.

In some examples, the tree model comprises a leaf group, and the leaf group has a specified minimum size. That is, there can be a minimal size for a leaf group in the tree. A leaf can generally comprise a vertex in a graph that represents the tree that has no children, and a leaf group can comprise leaves that share a common parent vertex.

In some examples, the labeled training data indicates the respective maintenance costs with respective confidence intervals. That is, the fitting data can comprise maintenance costs with confidence intervals provided by a different model. Put another way, the fitted model can work on a population of populations (e.g., a set of disks of a certain model possessed by a single user account).

After operation 404, process flow 400 moves to operation 406.

Operation 406 depicts, in response to applying a first input to the fitted model, producing an output that indicates a predicted maintenance cost distribution, wherein the first input comprises a feature of a user of the users and a product of the products. That is, once the model is trained in operation 404, it can be used to determine a distribution of predicted maintenance costs for a given user account and computer product.

In some examples, operation 406 comprises determining a risk distribution for the first input based on the predicted maintenance cost distribution. That is, a maintenance cost distribution that is determined by the fitted model can be translated to a risk distribution.

After operation 406, process flow 400 moves to 408, where process flow 400 ends.

FIG. 5 illustrates an example process flow 500 that can facilitate inference of risk distributions, in accordance with an embodiment of this disclosure. In some examples, one or more embodiments of process flow 500 can be implemented by inference of risk distributions component 108 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, and/or process flow 900 of FIG. 9.

Process flow 500 begins with 502, and moves to operation 504. Operation 504 depicts, in response to applying a first input to a fitted model, producing an output that indicates a predicted maintenance cost distribution, wherein the first input comprises a feature of a user and a product. In some examples, operation 504 can be implemented in a similar manner as operation 406 of FIG. 4.

After operation 504, process flow 500 moves to operation 506.

Operation 506 depicts determining a risk distribution for the first input based on the predicted maintenance cost distribution. That is, a maintenance cost distribution that is determined by the fitted model can be translated to a risk distribution.

After operation 506, process flow 500 moves to 508, where process flow 500 ends.

FIG. 6 illustrates an example process flow 600 that can facilitate inference of risk distributions, in accordance with an embodiment of this disclosure. In some examples, one or more embodiments of process flow 600 can be implemented by inference of risk distributions component 108 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, and/or process flow 900 of FIG. 9.

Process flow 600 begins with 602, and moves to operation 604. Operation 604 depicts applying a first input to a tree model that comprises a splitting criterion that comprises a Kullback-Leibler divergence among respective maintenance costs of two subgroups that result from a split of the first input. That is, a splitting criterion can be a Kullback-Leibler divergence among the two resulting subsets from the split.

After operation 604, process flow 600 moves to operation 606.

Operation 606 depicts normalizing a splitting score of the Kullback-Leibler divergence based on a size of the subgroups. That is, the splitting score given by the score of the Kullback-Leibler divergence can be normalized by size of the two subgroups.

After operation 606, process flow 600 moves to operation 608.

Operation 608 depicts producing an output from the fitted model that indicates a predicted maintenance cost distribution. In some examples, operation 608 can be implemented in a similar manner as operation 406 of FIG. 4.

After operation 608, process flow 600 moves to 610, where process flow 600 ends.

FIG. 7 illustrates an example process flow 700 that can facilitate inference of risk distributions, in accordance with an embodiment of this disclosure. In some examples, one or more embodiments of process flow 700 can be implemented by inference of risk distributions component 108 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 600 of FIG. 6, process flow 800 of FIG. 8, and/or process flow 900 of FIG. 9.

Process flow 700 begins with 702, and moves to operation 704. Operation 704 depicts fitting an artificial intelligence risk model to produce a first fitted model. In some examples, operation 704 can be implemented in a similar manner as operation 404 of FIG. 4.

After operation 704, process flow 700 moves to operation 706.

Operation 706 depicts refitting the first fitted model to produce a second fitted model based on data that is collected subsequent to producing the first fitted model. That is, the fitted model is refitted following new data collected with time.

After operation 704, process flow 700 moves to 708, where process flow 700 ends.

FIG. 8 illustrates an example process flow 800 that can facilitate inference of risk distributions, in accordance with an embodiment of this disclosure. In some examples, one or more embodiments of process flow 800 can be implemented by inference of risk distributions component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 600 of FIG. 6, process flow 700 of FIG. 7, and/or process flow 900 of FIG. 9.

Process flow 800 begins with 802, and moves to operation 804. Operation 804 depicts fitting an artificial intelligence risk model to data based on labeled training data to produce a fitted model, wherein the labeled training data comprises respective features of users and products, and corresponding labels of respective maintenance costs applicable to the products. In some examples, operation 804 can be implemented in a similar manner as operation 404 of FIG. 4.

In some examples, the fitted model comprises a tree model that is configured to differentiate between groups of the data with differing maintenance cost distributions.

In some examples, the tree model comprises an uplift tree model.

In some examples, the tree model has a defined maximum depth value. That is, the tree can have a limited depth.

In some examples, the tree model comprises a defined maximum number of leaves. That is, the tree can have a limited number of leaves.

In some examples, the tree model is configured to use a defined maximum number of features of the first input in performing a split. That is, it can be that a number of features that could be used for splits is limited.

In some examples, the tree model is configured to explore performing a split using genetic programming. That is, it can be that a split operation is explored dynamically using genetic programming.

After operation 804, process flow 800 moves to operation 806.

Operation 806 depicts, in response to applying a first input to the fitted model, producing an output that indicates a predicted maintenance cost distribution, wherein the first input comprises a feature of a user of the users and a product of the products. In some examples, operation 806 can be implemented in a similar manner as operation 406 of FIG. 4.

After operation 806, process flow 800 moves to 808, where process flow 800 ends.

FIG. 9 illustrates an example process flow 900 that can facilitate inference of risk distributions, in accordance with an embodiment of this disclosure. In some examples, one or more embodiments of process flow 900 can be implemented by inference of risk distributions component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 600 of FIG. 6, process flow 700 of FIG. 7, and/or process flow 800 of FIG. 8.

Process flow 900 begins with 902, and moves to operation 904. Operation 904 depicts fitting an artificial intelligence risk model to data based on labeled training data to produce a fitted model, wherein the labeled training data comprises respective features of users and products, and corresponding labels of respective maintenance costs applicable to the products. In some examples, operation 904 can be implemented in a similar manner as operation 404 of FIG. 4.

In some examples, the fitted model comprises a tree model that is configured to differentiate between groups of the data with differing maintenance cost distributions. In some examples, the first input comprises a feature of a user of the users and a product of the products.

After operation 904, process flow 900 moves to operation 906.

Operation 906 depicts, in response to applying a first input to the fitted model, producing an output that indicates a predicted maintenance cost distribution. In some examples, operation 906 can be implemented in a similar manner as operation 406 of FIG. 4.

In some examples, the fitted model comprises a first model that is configured to output different risk types, and a model that is configured to integrate multiple risk types of the different risk types to produce the output. In some examples, the first model comprises multiple models. In some examples, respective models of the multiple models are configured to output respective different risk types of the different risk types. That is, it can be that there are one or more models that are used to output different risk types, and an additional model integrating the predictions for each customer based on requirement.

After operation 906, process flow 900 moves to 908, where process flow 900 ends.

### Example Architecture

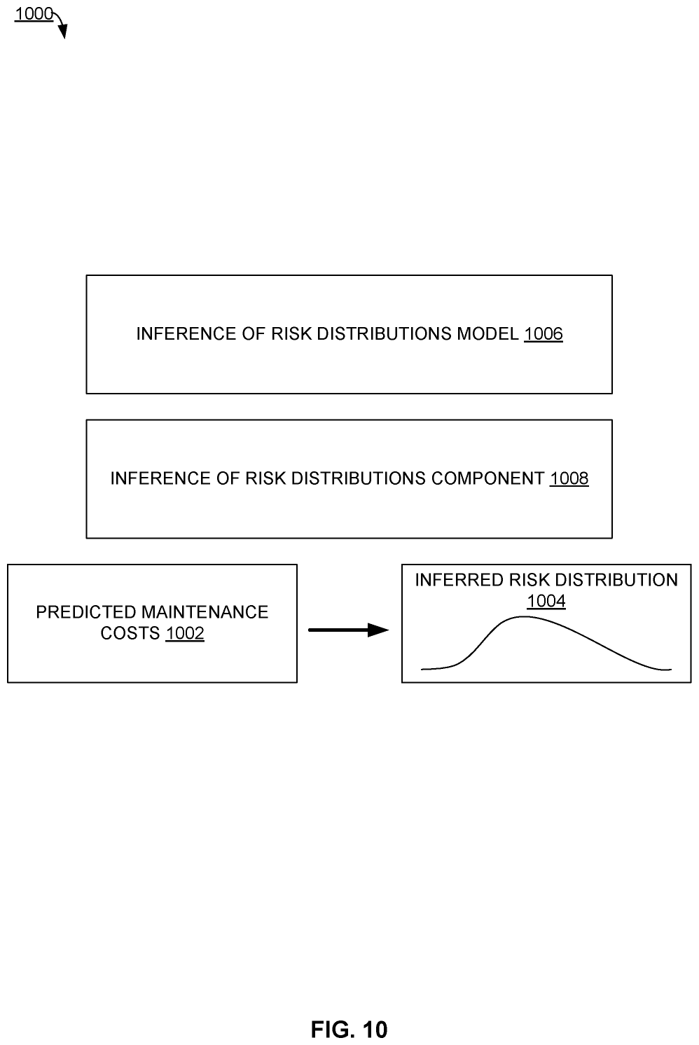

FIG. 10 illustrates another example system architecture 1000 that can facilitate inference of risk distributions, in accordance with an embodiment of this disclosure. In some examples, part(s) of system architecture 1000 can be used to implement part(s) of system architecture 100 of FIG. 1.

System architecture 1000 comprises predicted maintenance costs 1002, inferred risk distribution 1004, inference of risk distributions model 1006, and inference of risk distributions component 1008. Predicted maintenance costs 1002 can comprise a group of predicted maintenance cost output by inference of risk distributions model 1006. Inferred risk distribution 1004 can comprise a risk distribution that is generated from predicted maintenance costs 1002 by inference of risk distributions component 1008. Inference of risk distributions model 1006 can be similar to inference of risk distributions model 106 of FIG. 1. Inference of risk distributions component 1008 can be similar to inference of risk distributions component 108 of FIG. 1.

In some examples, it can be that knowing a distribution of risk (e.g., inferred risk distribution 1004) is preferred to knowing expected values (e.g., predicted maintenance costs 1002). A splitting criterion can be a divergence of two resulting distributions of a splits subsets, normalized by their sizes; or by enforcing a minimal size for a leaf node in a tree.

That is, the present techniques can be implemented to use tree-based models (e.g., inference of risk distributions model 1006) with divergence to differentiate between subsets of data with differing distributions. A benefit of this approach can be to infer risk distributions, which can facilitate users in preparing for multiple possibilities, rather than an average possibility.

In a regular tree model, a split can be performed to obtain the most homogenous labels at each side of the split, and each leaf can indicate a predicted value, which can be the regular tree model's output. In some examples, the present techniques can involve using a model (such as an uplift tree model) where the split is performed according to a certain feature to split to two subsets of label populations so that they will be the most different from each other (or where the difference between the two populations is above a defined difference criterion value). A distribution of the population at the leave can provide the risk distribution used in the present techniques.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of server 102 and/or user site 112 of FIG. 1.

In some examples, computing environment 1100 can implement one or more embodiments of the process flows of FIGS. 4-9 to facilitate inference of risk distributions.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
fitting an artificial intelligence risk model to data based on labeled training data to produce a fitted model, wherein the labeled training data comprises respective features of users and products, and corresponding labels of respective maintenance costs applicable to the products, and wherein the fitted model comprises a tree model that is configured to differentiate between groups of the data with differing maintenance cost distributions; and
in response to applying a first input to the fitted model, producing an output that indicates a predicted maintenance cost distribution, wherein the first input comprises a feature of a user of the users and a product of the products.

2. The system of claim 1, wherein the operations further comprise:
determining a risk distribution for the first input based on the predicted maintenance cost distribution.

3. The system of claim 1, wherein the tree model comprises a splitting criterion that comprises a Kullback-Leibler divergence among respective maintenance costs of two subgroups that result from a split of the first input.

4. The system of claim 3, wherein the operations further comprise:
normalizing a splitting score of the Kullback-Leibler divergence based on a size of the subgroups.

5. The system of claim 1, wherein the tree model comprises a leaf group, and wherein the leaf group has a specified minimum size.

6. The system of claim 1, wherein the data is first data, wherein the fitted model is a first fitted model, and wherein the operations further comprise:
refitting the first fitted model to produce a second fitted model based on second data that is collected subsequent to producing the first fitted model.

7. The system of claim 1, wherein the labeled training data indicates the respective maintenance costs with respective confidence intervals.

8. A method, comprising:
fitting, by a system comprising a processor, an artificial intelligence risk model to data based on labeled training data to produce a fitted model, wherein the labeled training data comprises respective features of users and products, and corresponding labels of respective maintenance costs applicable to the products; and
in response to applying a first input to the fitted model, producing, by the system, an output that indicates a predicted maintenance cost distribution, wherein the first input comprises a feature of a user of the users and a product of the products.

9. The method of claim 8, wherein the fitted model comprises a tree model that is configured to differentiate between groups of the data with differing maintenance cost distributions.

10. The method of claim 9, wherein the tree model comprises an uplift tree model.

11. The method of claim 9, wherein the tree model has a defined maximum depth value.

12. The method of claim 9, wherein the tree model comprises a defined maximum number of leaves.

13. The method of claim 9, wherein the tree model is configured to use a defined maximum number of features of the first input in performing a split.

14. The method of claim 9, wherein the tree model is configured to explore performing a split using genetic programming.

15. A non-transitory computer-readable medium comprising instructions that, in response to execution, cause a system comprising a processor to perform operations, comprising:
fitting an artificial intelligence risk model to data based on labeled training data to produce a fitted model, wherein the labeled training data comprises respective features of users and products, and corresponding labels of respective maintenance costs applicable to the products; and
in response to applying a first input to the fitted model, producing an output that indicates a predicted maintenance cost distribution.

16. The non-transitory computer-readable medium of claim 15, wherein the fitted model comprises a tree model that is configured to differentiate between groups of the data with differing maintenance cost distributions.

17. The non-transitory computer-readable medium of claim 15, wherein the first input comprises a feature of a user of the users and a product of the products.

18. The non-transitory computer-readable medium of claim 15, wherein the fitted model comprises a first model that is configured to output different risk types, and a second model that is configured to integrate multiple risk types of the different risk types to produce the output.

19. The non-transitory computer-readable medium of claim 18, wherein the first model comprises multiple models.

20. The non-transitory computer-readable medium of claim 19, wherein respective models of the multiple models are configured to output respective different risk types of the different risk types.
